(19) United States
(12) Patent Application Publication
(10) Pub. No.: US 2017/0370148 A1
(43) Pub. Date: Dec. 28, 2017

(54) Drawer-Integrated Step Stool

(71) Applicant: Fred Smith, Courtice (CA)

(72) Inventor: Fred Smith, Courtice (CA)

(21) Appl. No.: 15/191,719

(22) Filed: Jun. 24, 2016

(51) Int. Cl. E06C 1/00; A47C 12/00

(52) U.S. Cl. CPC E06C 1/005; A47C 12/00; A47B 2220/05

(57) ABSTRACT

A drawer-integrated step stool for selective extension from a drawer includes a box that is substantially complementary to a recess of a cabinet. The box is configured to slidably couple to the cabinet, such that the box is extensible from the recess. The box has an upper face, which is open. Stairs, positioned in the box, have a bottom that is pivotally coupled to opposing sides of the box proximate to a front. A lift, coupled to and positioned in the box, is operationally coupled to a top of the stairs. An actuator, coupled to the box, is operationally coupled to the lift. The actuator is configured for activation by a foot of a user to compel the box to extend from the recess and to signal the lift to elevate the stairs through the upper face, wherein the stairs are configured for ascension by the user.

### BACKGROUND OF THE DISCLOSURE

### Field of the Disclosure

The disclosure relates to step stools and more particularly pertains to a new step stool for selective extension from a drawer.

### SUMMARY OF THE DISCLOSURE

An embodiment of the disclosure meets the needs presented above by generally comprising a box that is substantially complementary to a recess of a cabinet. The box is configured to slidably couple to the cabinet, such that the box is extensible from the recess. The box has an upper face, which is open. Stairs, positioned in the box, have a bottom that is pivotally coupled to opposing sides of the box proximate to a front. A lift, coupled to and positioned in the box, is operationally coupled to a top of the stairs. An actuator, coupled to the box, is operationally coupled to the lift. The actuator is configured for activation by a foot of a user to compel the box to extend from the recess and to signal the lift to elevate the stairs through the upper face, wherein the stairs are configured for ascension by the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a drawer-integrated step stool according to an embodiment of the disclosure.

FIG. 2 is a side view of an embodiment of the disclosure.

FIG. 3 is a front view of an embodiment of the disclosure.

FIG. 4 is a top view of an embodiment of the disclosure.

FIG. 5 is an exploded view of an embodiment of the disclosure.

### DESCRIPTION OF THE PREFERRED EMBODIMENT

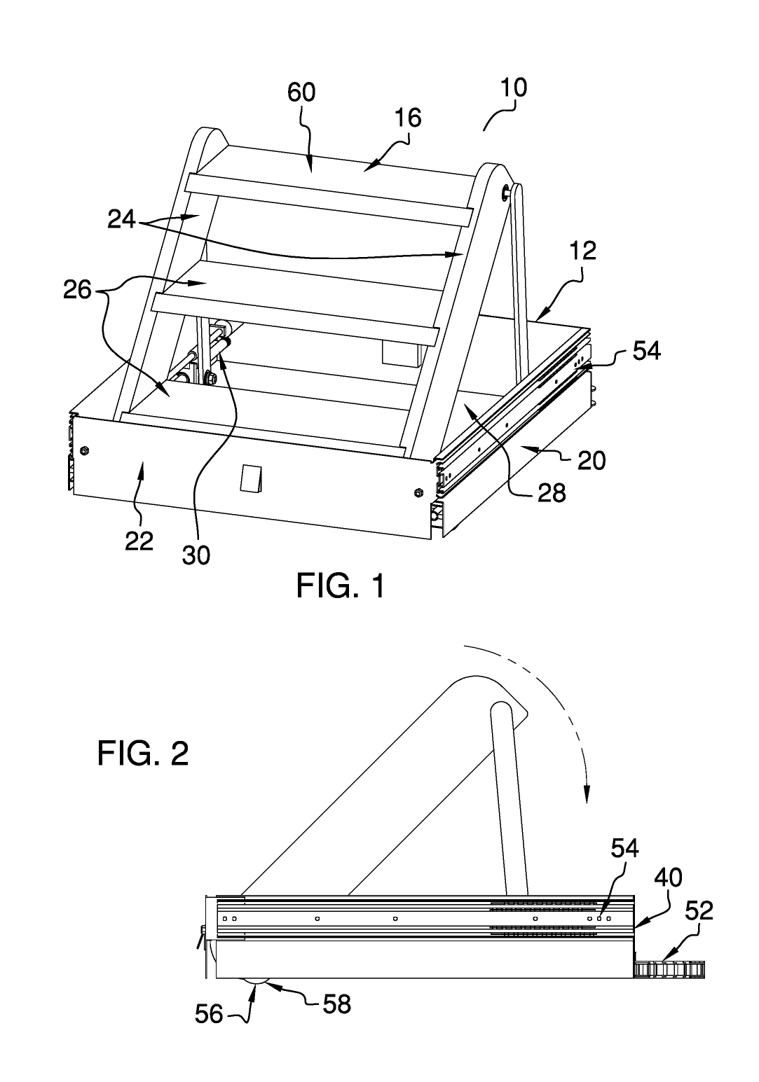

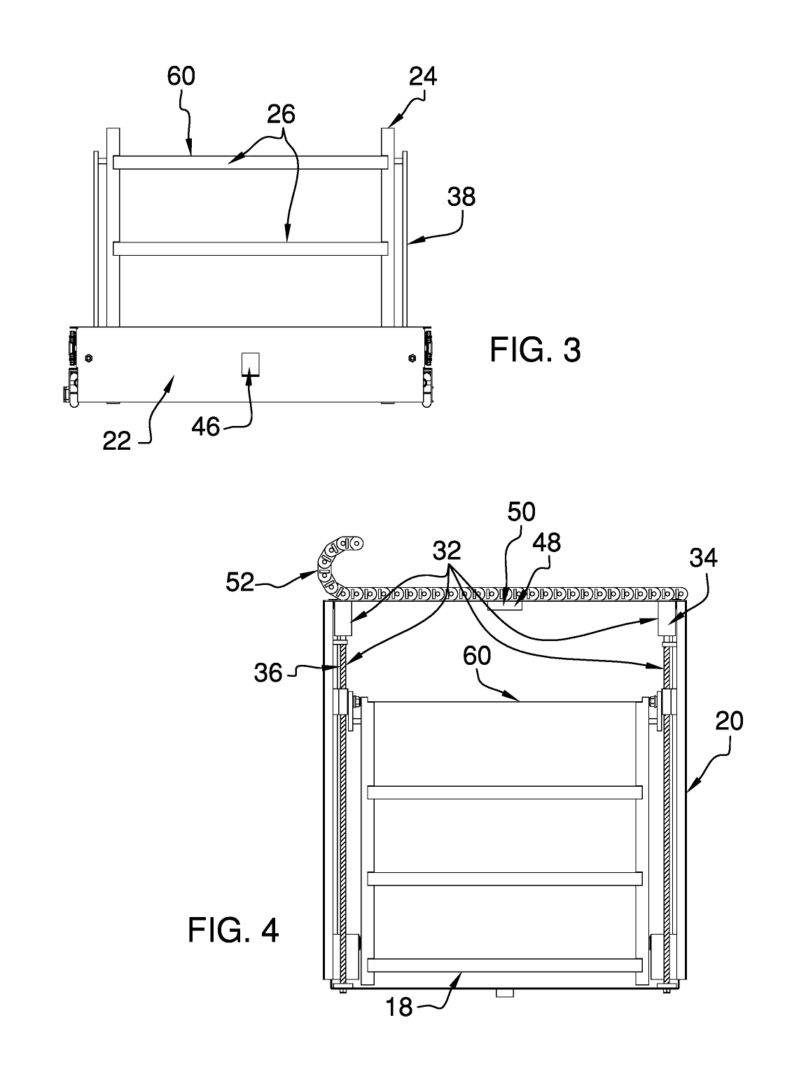

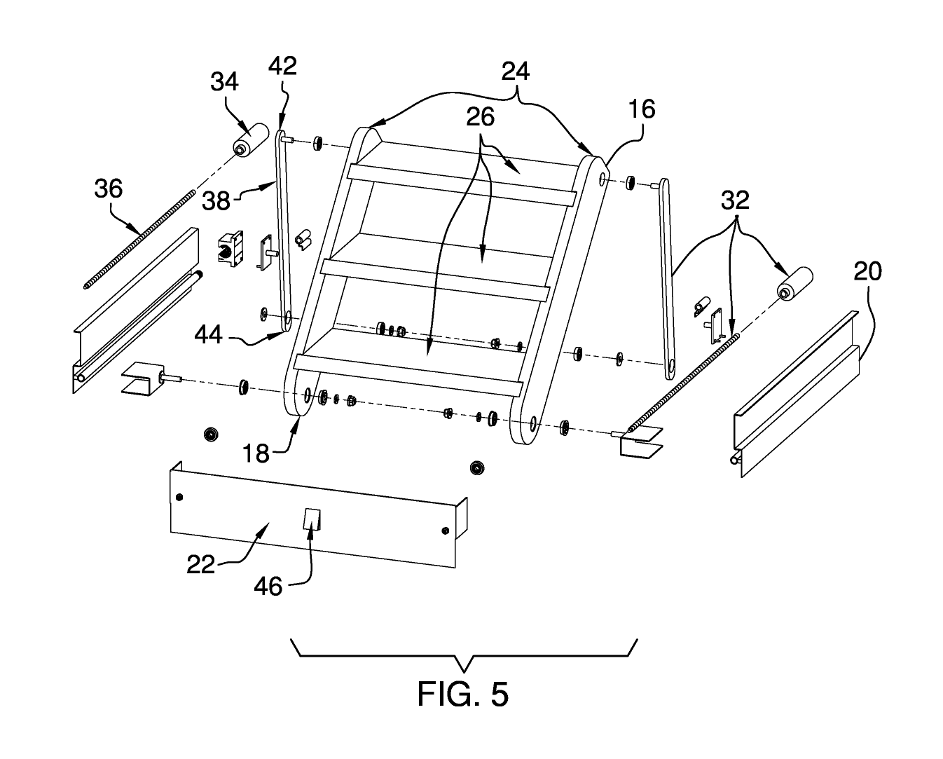

With reference now to the drawings, and in particular to FIGS. 1 through 5 thereof, a new step stool embodying the principles and concepts of an embodiment of the disclosure and generally designated by the reference numeral 10 will be described.

As best illustrated in FIGS. 1 through 5, the drawer-integrated step stool 10 generally comprises a box 12. The box 12 is substantially complementary to a recess of a cabinet. The box 12 is configured to slidably couple to the cabinet, such that the box 12 is extensible from the recess. The box 12 has an upper face 14, which is open.

Stairs 16 are positioned in the box 12. The stairs 16 have a bottom 18. The bottom 18 is pivotally coupled to each opposing side 20 of the box 12 proximate to a front 22 of the box 12. The stairs 16 comprise a pair of side rails 24 and a plurality of planks 26. Each plank 26 is coupled to and extends between the side rails 24. The planks 26 are coupled to the side rails 24 such that the planks 26 are substantially perpendicular to a lower face 28 of the box 12 when the side rails 24 are substantially parallel to the lower face 28. Additionally, the planks 26 are coupled to the side rails 24 such that the planks 26 are substantially parallel to the lower face 28 when the side rails 24 are positioned substantially forty five degrees from the lower face 28.

In one embodiment, the plurality of planks 26 comprises from one to five planks 26. In another embodiment, the plurality of planks 26 comprises from two to four planks 26. In yet another embodiment, the plurality of planks 26 comprises three planks 26.

A lift 30 is coupled to and positioned in the box 12. The lift 30 is operationally coupled to a top 60 of the stairs 16. The lift 30 comprises a pair of drives 32. Each drive 32 is coupled to and positioned in the box 12 proximate to a respective opposing side 20. Each drive 32 is operationally coupled to the top 60 of the stairs 16. The drives 32 are positioned to elevate the stairs 16 through the upper face 14.

In one embodiment, each drive 32 comprises a motor 34, a shaft 36 and a support 38. The motor 34 is positioned proximate to a back 40 of the box 12. The shaft 36 is coupled to and extends from the motor 34 in parallel to the respective opposing side 20. The shaft 36 is threaded. The shaft 36 is rotationally coupled to the front 22 of the box 12. The support 38 is pivotally coupled by a first end 42 to a respective side rail 24 proximate to the top 60 of the stairs 16. The support 38 has a second end 44 that is threadedly coupled to the shaft 36. The shaft 36 is coupled to the motor 34 such that the motor 34 is positioned to rotate the shaft 36. The second end 44 of the support 38 is compelled from proximate to the front 22 of the box 12 to proximate to the motor 34, such that the support 38 is compelled from a substantially horizontal position to a substantially vertical position. Concurrently, the stairs 16 are extended from the box 12. The motor 34 also is positioned to reverse rotation of the shaft 36 to compel the support 38 from the substantially vertical position to the substantially horizontal position to retract the stairs 16 into the box 12.

An actuator 46 is coupled to the front 22 of the box 12. The actuator 46 is operationally coupled to the lift 30. The actuator 46 is substantially centrally positioned on the front 22 of the box 12.

A controller 48 is coupled to the back 40 and positioned in the box 12. The controller 48 is operationally coupled to the motors 34 and the actuator 46. The actuator 46 is positioned to signal the controller 48 to compel the motors 34 to raise and lower the stairs 16. The controller 48 comprises a coupler 50. The coupler 50 is configured to couple the controller 48 to a power source.

A cable carrier 52 is coupled to the back 40 of the box 12. The cable carrier 52 is positioned on the box 12 such that the cable carrier 52 is configured to house and protect a power cord coupled to the coupler 50 of the controller 48.

Each of a pair of tracks 54 is coupled to a respective opposing side 20 of the box 12 proximate to the upper face 14. The tracks 54 are positioned on the opposing sides 20 of the box 12 such that the tracks 54 are configured to rollably couple to rotatable discs coupled to the cabinet within the recess.

A pair of rollers 56 is rotationally coupled to the lower face 28 of the box 12 proximate to the front 22 of the box 12. The rollers 56 are positioned on the box 12 such that the rollers 56 are configured to support the box 12 as the box 12 is extended from the recess in the cabinet. In one embodiment, the rollers 56 comprise wheels 58. The wheels 58 comprise rubber.

In use, the actuator 46 is configured for activation by a foot of a user to compel the box 12 to extend from the recess in the cabinet and to signal the lift 30 to elevate the stairs 16 through the upper face 14, such that the stairs 16 are configured for ascension by the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drawer-integrated step stool comprising:
a box, said box being substantially complementary to a recess of a cabinet, said box being configured for slidable coupling to the cabinet, such that said box is extensible from the recess, said box having a upper face, said upper face being open;
stairs positioned in said box, said stairs having a bottom, said bottom being pivotally coupled to each opposing side of said box proximate to a front of said box;
a lift coupled to and positioned in said box, said lift being operationally coupled to a top of said stairs;
an actuator coupled to said front of said box, said actuator being operationally coupled to said lift; and
wherein said actuator is configured for activation by a foot of a user to compel said box to extend from the recess in the cabinet and to signal said lift to elevate said stairs through said upper face, such that said stairs are configured for ascension by the user.

2. The step stool of claim 1, further including said stairs comprising:
a pair of side rails; and
a plurality of planks, each said plank being coupled to and extending between said side rails, said planks being coupled to said side rails such that said planks are substantially perpendicular to a lower face of said box when said side rails are substantially parallel to said lower face, said planks being coupled to said side rails such that said planks are substantially parallel to said lower face when said side rails are positioned substantially forty five degrees from said lower face.

3. The step stool of claim 2, further including said plurality of planks comprising from one to five said planks.

4. The step stool of claim 3, further including said plurality of planks comprising from two to four said planks.

5. The step stool of claim 4, further including said plurality of planks comprising three said planks.

6. The step stool of claim 1, further including said lift comprising a pair of drives, each said drive being coupled to and positioned in said box proximate to a respective said opposing side, each said drive being operationally coupled to said top of said stairs, wherein said drives are positioned to elevate said stairs through said upper face.

7. The step stool of claim 6, further including each said drive comprising:
a motor positioned proximate to a back of said box;
a shaft coupled to and extending from said motor in parallel to said respective said opposing side, said shaft being threaded, said shaft being rotationally coupled to said front of said box;
a support pivotally coupled by a first end to a respective said side rail proximate to said top of said stairs, said support having a second end threadedly coupled to said shaft; and
wherein said shaft is coupled to said motor such that motor is positioned to rotate said shaft, wherein said second end of said support is compelled from proximate to said front of said box to proximate to said motor, wherein said support is compelled from a substantially horizontal position to a substantially vertical position, wherein said stairs are extended from said box, wherein said motor is positioned to reverse rotation of said shaft to compel said support from the substantially vertical position to the substantially horizontal position to retract said stairs into said box.

8. The step stool of claim 1, further including said actuator being substantially centrally positioned on said front of said box.

9. The step stool of claim 7, further including a controller coupled to said back and positioned in said box, said controller being operationally coupled to said motors and said actuator, wherein actuator is positioned to signal said controller to compel said motors to raise and lower said stairs.

10. The step stool of claim 9, further including said controller comprising a coupler, wherein said coupler is configured for coupling said controller to a power source.

11. The step stool of claim 10, further including a cable carrier coupled to said back of said box, wherein said cable carrier is positioned on said box such that said cable carrier is configured to house and protect a power cord coupled to said coupler of said controller.

12. The step stool of claim 1, further including a pair of tracks, each said track being coupled to a respective said opposing side of said box proximate to said upper face, wherein said tracks are positioned on said opposing sides of said box such that said tracks are configured to rollably couple to rotatable discs coupled to the cabinet within the recess.

13. The step stool of claim 1, further including a pair of rollers rotationally coupled to a lower face of said box proximate to said front of said box, wherein said rollers are positioned on said box such that said rollers are configured to support said box as said box is extended from the recess in the cabinet.

14. The step stool of claim 13, further including said rollers comprising wheels.

15. The step stool of claim 14, further including said wheels comprising rubber.

16. A drawer-integrated step stool comprising:
a box, said box being substantially complementary to a recess of a cabinet, said box being configured for slidable coupling to the cabinet, such that said box is extensible from the recess, said box having a upper face, said upper face being open;
stairs positioned in said box, said stairs having a bottom, said bottom being pivotally coupled to each opposing side of said box proximate to a front of said box, said stairs comprising:
a pair of side rails, and
a plurality of planks, each said plank being coupled to and extending between said side rails, said planks being coupled to said side rails such that said planks are substantially perpendicular to a lower face of said box when said side rails are substantially parallel to said lower face, said planks being coupled to said side rails such that said planks are substantially parallel to said lower face when said side rails are positioned substantially forty five degrees from said lower face, said plurality of planks comprising from one to five said planks, said plurality of planks comprising from two to four said planks, said plurality of planks comprising three said planks;
a lift coupled to and positioned in said box, said lift being operationally coupled to a top of said stairs, said lift comprising a pair of drives, each said drive being coupled to and positioned in said box proximate to a respective said opposing side, each said drive being operationally coupled to said top of said stairs, wherein said drives are positioned to elevate said stairs through said upper face, each said drive comprising:
a motor positioned proximate to a back of said box,
a shaft coupled to and extending from said motor in parallel to said respective said opposing side, said shaft being threaded, said shaft being rotationally coupled to said front of said box,
a support pivotally coupled by a first end to a respective said side rail proximate to said top of said stairs, said support having a second end threadedly coupled to said shaft, and
wherein said shaft is coupled to said motor such that motor is positioned to rotate said shaft, wherein said second end of said support is compelled from proximate to said front of said box to proximate to said motor, wherein said support is compelled from a substantially horizontal position to a substantially vertical position, wherein said stairs are extended from said box, wherein said motor is positioned to reverse rotation of said shaft to compel said support from the substantially vertical position to the substantially horizontal position to retract said stairs into said box;
an actuator coupled to said front of said box, said actuator being operationally coupled to said lift, said actuator being substantially centrally positioned on said front of said box;
a controller coupled to said back and positioned in said box, said controller being operationally coupled to said motors and said actuator, wherein actuator is positioned to signal said controller to compel said motors to raise and lower said stairs, said controller comprising a coupler, wherein said coupler is configured for coupling said controller to a power source;
a cable carrier coupled to said back of said box, wherein said cable carrier is positioned on said box such that said cable carrier is configured to house and protect a power cord coupled to said coupler of said controller;
a pair of tracks, each said track being coupled to a respective said opposing side of said box proximate to said upper face, wherein said tracks are positioned on said opposing sides of said box such that said tracks are configured to rollably couple to rotatable discs coupled to the cabinet within the recess;
a pair of rollers rotationally coupled to said lower face of said box proximate to said front of said box, wherein said rollers are positioned on said box such that said rollers are configured to support said box as said box is extended from the recess in the cabinet, said rollers comprising wheels, said wheels comprising rubber; and
wherein said actuator is configured for activation by a foot of a user to compel said box to extend from the recess in the cabinet and to signal said lift to elevate said stairs through said upper face, such that said stairs are configured for ascension by the user.
